(19) United States
(12) Patent Application Publication
(10) Pub. No.: US 2026/0092494 A1
(43) Pub. Date: Apr. 2, 2026

(54) ASSEMBLY FOR INSULATED GLAZING AND INSULATED GLAZING

(71) Applicants: Pilkington Group Limited, Lathom (GB); Technoform Glass Insulation Holding GmbH, Lohfelden (DE)

(72) Inventors: Marcel RIBBERINK, SB ENSCHEDE (NL); Christoph HAYN, Gelsenkirchen (DE); Arthur KNOLL, Lohfelden (DE); Marek FRANK, Lohfelden (DE)

(21) Appl. No.: 19/110,910

(22) PCT Filed: Sep. 12, 2023
(86) PCT No.: PCT/EP2023/075055

§ 371 Date: Mar. 12, 2025

(30) Foreign Application Priority Data
Sep. 13, 2022 (EP) 22195339.1

(51) Int. Cl. E06B 3/673; H01R 13/502

(52) U.S. Cl. CPC E06B 3/67326; H01R 13/502

(57) ABSTRACT

The present application discloses an assembly suitable for arrangement between a first glazing pane and a second glazing pane of an insulated glazing, the assembly comprising an aperture suitable for a contact comprising a first contact point and a second contact point and a resilient structure that is tensioned during manufacture of the insulated glazing, such that following manufacture of the insulated glazing the first contact point is held securely against the electrical component, the first contact point having a contact area of less than 1 cm², also disclosed are a method of manufacturing such an assembly, an insulated glazing comprising such an assembly, and a method of manufacturing such an insulated glazing.

The present invention relates to an assembly suitable for arrangement between a first glazing pane and a second glazing pane of an insulated glazing, a method of manufacturing such an assembly, an insulated glazing comprising such an assembly, and a method of manufacturing such an insulated glazing.

Glazings are commonly installed into apertures in buildings: such apertures may be in the building envelope or within the building itself. Such glazings may be insulated glazings, wherein at least two glazing panes are arranged in a face-to-face configuration with a cavity therebetween. The cavity is generally maintained by a spacer between the sheets of glazing material, and the cavity typically comprises an insulating gas, but in some cases the cavity may comprise a vacuum. In either case, a hermetic seal is typically provided around the periphery and between the sheets of glazing material to preserve the atmosphere of the cavity. An insulated glazing may also be termed an insulated glazing unit or insulating glazing unit (IGU).

In some cases, insulated glazings may comprise electrical components which require electrical energy. Previous methods of supplying electrical energy to electrical components situated within the cavity have included the use of cables soldered to the electrical component.

For example, GB 1262372 describes a conductor that extends through a grommet in a separator strip, and a sleeve surrounding the conductor to electrically insulate the conductor from the grommet and separator strip and to hermetically seal the grommet around the conductor. The conductor is soldered to a busbar.

However, solder connections are fragile, and therefore may break easily during insulated glazing unit production and/or installation, or following installation. In particular, glass panes may flex due to impacts, wind pressure, or due to a difference in pressure between the cavity and the external environment. Such flex may over time cause solders, which are often very brittle, to break and thereby degrade or completely prevent electrical connection. This may lead to wastage where the break occurs and is detected during production, or may lead to complete replacement if the solder connection fails after installation.

There have been previous attempts to provide alternative methods for connecting to an electrical component inside an insulated glazing.

Spacer profiles including methods for providing an electrical connection within an insulated glazing have been provided, for example WO2019086384A1 discloses a spacer for insulating glazing units with three or more glazing panes enclosing at least one hermetically sealed interspace between at least two glazing panes, comprising a groove adapted to receive an intermediate glazing pane and the spacer comprises at least two electrically conducting portions which are electrically isolated from each other and are positioned in one or both of the side walls and/or the bottom wall of the groove.

In addition, corner keys for providing an electrical connection within an insulated glazing have been provided. For example, U.S. Pat. No. 9,402,283B2 discloses a corner key assembly for an electrically heated insulating glass unit comprising a spring clip. The geometry of the spring clip is such that when the spring clip is compressed between two parallel panes of glass, the large flat surfaces of the spring clip will contact both parallel surfaces of glass in a flat manner, with full contact. However, such a spring clip contacts both surfaces, which may be unsuitable for some applications.

The aim of the invention is therefore to overcome the above mentioned disadvantages of previous methods of supplying electrical energy to electrical components situated within the cavity.

According to a first embodiment of the present invention, there is provided an assembly suitable for arrangement between a first glazing pane and a second glazing pane of an insulated glazing, wherein the first glazing pane comprises an electrical component on a first major surface orientated towards the second glazing pane, the assembly comprising:
a body comprising a first wall to be orientated towards the first glazing pane and a second wall to be orientated towards the second glazing pane; and
a contact receiving part comprising an aperture, wherein:
the aperture is suitable for a contact comprising a first contact point and a second contact point;
the aperture is orientated such that the first contact point is positioned to be suitable for direct or indirect contact with the electrical component when the assembly is arranged between the first glazing pane and the second glazing pane; and
the assembly comprises a resilient structure that is tensioned during manufacture of the insulated glazing, such that following manufacture of the insulated glazing the first contact point is held securely directly or indirectly against the electrical component; and wherein the first contact point has a contact area of less than 1 cm².

The inventors have advantageously learned that such a body, when combined with a contact, may be employed to provide a secure and solder free connection to an electrical component on a major surface of the first glazing pane. Where an assembly does not comprise a resilient structure, a contact which is held securely against the electrical component without solder is held by flexing of the glazing panes—this may result in undue stress on the glazing seals, damage to the electrical component, or even cause glass breakage. The introduction of a resilient structure into the assembly provides a secure connection while greatly reducing the risk of glazing seal rupture, electrical component damage, and glass breakage.

Electrical components suitable for use with the assembly of the present invention are not unduly restricted. For example, suitable electrical components may comprise, but are not limited to, heating coatings, printed heating lines, blinds, photovoltaic elements, displays, variable light transmission elements, busbars, and combinations of the same. The skilled person will appreciate that such electrical components should be electrically isolated from surfaces that are external to the insulated glazing to prevent risk of damage or injury.

As defined herein, the first contact point is held securely against the electrical component when a force of from 0.2 to 5 N is applied through the contact point towards the electrical component with a vector angle of from 10° to 180°, where 90° is perpendicular to a contacting part of the electrical component. Preferably, a force of from 0.5 to 1.8 N is applied through the contact point. More preferably, a force of from 0.75 to 1.4 N is applied through the contact point. A lower force is associated with a less secure electrical connection, while a higher force may cause damage to electrical components and/or glazing panes. Preferably, the vector angle is from 30° to 150°. More preferably, the vector angle is from 60° to 120°. Yet more preferably, the vector angle is from 80° to 100°. Even more preferably, the vector angle is from 85° to 95°. Most preferably, the vector angle is from 89° to 91°. A vector angle that is closer to 90° will provide a more secure connection.

In some embodiments, the body comprises said resilient structure. The resilient structure may take the form of flexible body feature that is conformed with the body, such as a lever, arm or other flexible feature that may be tensioned under load. However, it is beneficial that the reversibly compressible structure is in line with the first contact point, such that the force applied by the tensioned resilient structure forces the first contact point against the electrical component without the potential for deviation, which could result in poor contact or loss of the contact.

Preferably, the resilient structure comprises at least one spring or long lasting resilient material. Springs and long lasting resilient materials, such as rubber rods, are particularly durable and provide long lasting reversible compression. Preferably the resilient structure does not comprise foam, as such foams may degrade over time and thereby lose their tension, reducing the applied force between the first contact point and the electrical component and thus the electrical connection is degraded, as such a foam is not a long lasting resilient material.

The skilled person will appreciate that the resilient structure may be incorporated in many parts of the body. However, preferably the contact receiving part and/or the terminal where present and/or the contact where present comprise a reversibly compressible structure. These parts are most closely associated with the cavity and therefore are best suited to force the contact against an electrical component of the first glazing pane.

The aperture is orientated such that the first contact point directly or indirectly contacts the electrical component when the body is arranged between the first glazing pane and the second glazing pane. The skilled person will appreciate that such direct or indirect contact allows electrical transmission between the first contact point and the electrical component. As such, when the assembly is within an insulated glazing unit, an electrical connection is formed between the first contact point of the contact and the electrical component, thereby allowing electrical communication between the electrical component and a power and/or data source outside the insulated glazing, without solder between the contact and the electrical elements—as such a solder-free connection is provided. Preferably the first contact point is in direct contact with the electrical component, and directly held against it. Preferably, the aperture is orientated substantially perpendicular to the major face of the first glazing pane. Substantially perpendicular is defined herein as between 60 and 120 degrees to the glazing pane. An aperture that is orientated substantially perpendicular to the major face of the first glazing pane has the advantage that a more secure connection may be accomplished between the contact and the electrical component on the first glazing pane.

Preferably, the contact does not make contact with the second glazing pane and/or the contact is not in electrical communication with an electrical component on the second glazing pane. This is particularly beneficial where the second glazing pane is provided with a coating, such as an infrared-radiation reflection coating, that comprises a conductive layer. In such cases, where it is not desired to use such a coating as a heating coating, such coating should not become electrified, as this may cause insulated glazing spacer frame members, or even the periphery of the insulated glazing, to become electrified and thereby risk damage or danger to users. In addition, where the contact makes contact with both the second glazing pane and the first glazing pane, or electrical components associated therewith, the contact may form a thermal bridge between the glazing panes, thereby reducing the energy efficiency of the glazing. In particular, a thermal bridge may cause condensation to form on the internal pane where a part of the pane in contact with the thermally bridging contact is significantly colder than other parts of the pane.

Preferably, the aperture is orientated such that an aperture opening is orientated towards the first glazing pane. Such an arrangement allows a linear contact to be provided which may be smaller and less visible to end users than alternative contacts, such as sprung clips.

Prior to arrangement between the first glazing pane and the second glazing pane, the assembly is provided with the contact. Therefore, in some embodiments the assembly further comprises the contact comprising a first contact point and a second contact point, wherein the contact is at least partially within the aperture.

Preferably the contact comprises metals or alloys. Preferably, the contact comprises gold, nickel, palladium-nickel, copper-zinc-tin, palladium cobalt, copper, brass or mixtures of the same. The contact may comprise conductive coatings that improve the electrical transmission between the contact and the electrical component.

In some embodiments the contact is at least partially inserted into the aperture immediately prior to preparation of the spacer frame for the insulated glazing, or even immediately prior to preparation of the insulated glazing. Alternatively, the contact may be preassembled with the body, such that an assembly comprising the contact may be mass produced. For example, the contact may be encapsulated in the aperture during manufacture of the body, for example during 3D printing or moulding.

The first contact point has a contact area of less than 1 cm², more preferably less than 0.5 cm², even more preferably less than 0.1 cm². A smaller contact area reduces the risk of scratching of the glass surface. In addition, a smaller contact area allows for the use of multiple contacts, allowing redundancy to be introduced into the system. In addition, a smaller contact area increases the transmission of light through the glazing compared to a larger contact area. Furthermore, a smaller contact area reduces the risk of thermal bridging. Furthermore, a large contact area may exacerbate shrinking and expansion effects of the contact, which may cause the electrical connection between the contact point and the electrical component to become unreliable.

Preferably, the first contact point is a point-type contact point, preferably a spherical or hemispherical contact point. A point-type contact point, especially a spherical or hemispherical contact point, allows for greatly reduced risk of scratching. Furthermore, a point-type contact allows for a consistent contact area to be maintained despite movement of the glazing panes A captured spherical contact point is particularly preferred, as this may roll and therefore the risk of scratching is greatly reduced.

While in some embodiments the contact may comprise the resilient structure, it is preferred that the resilient structure is not a substantially electrically conductive resilient structure. In particular, preferably the contact point is not a part of the resilient structure. This is because resilient structures are commonly formed from materials suitable for providing long lasting resilient behaviour, but such materials are often not suitable for electrical transmission due to, for example, high resistivity. For example, a steel spring is an excellent resilient structure and may be used in the present invention, but preferably is not used as a conductor or to provide a contact point, as high resistance may lead to low efficiency of electrical transmission and high temperatures in the assembly, which is undesirable as some materials of the assembly may be melted by localised high temperatures, such as when parts of the assembly comprise plastics or resins. Conversely, a brass or copper spring may be a good conductor, but does not provide long lasting resilient behaviour due to the softness of the materials.

Preferably, the resilient structure applies a spring force from 25 g to 500 g. More preferably, the resilient structure applies a spring force from 50 g to 250 g. Even more preferably, the resilient structure applies a spring force from 80 g to 150 g, and yet more preferably a spring force from 90 g to 120 g.

The inventors have discovered that such spring forces allow a secure yet mechanically flexible electrical connection to be made. Spring forces above this range may result in a resilient structure that is not sufficiently compressible, and therefore causes damage to a busbar or a corner key body, or even to the glass panes. Spring forces below this range may result in a resilient structure that has insufficient rebound, and therefore a secure electrical connection is not established.

Preferably, the contact comprises a sprung barrel contact. A sprung barrel contact may be known as a “pogo pin”. Such contacts typically comprise a barrel with an opening and a pin partially captured within the barrel that moves independently of the barrel and may extend to different extents from the opening. The barrel comprises a spring or resilient material, such that the pin may be reversibly pushed into the barrel, preferably the spring is a stainless steel spring. In some cases the sprung barrel contact may comprise a cylindrical barrel and/or the barrel may comprise locating features such as flanges. Such sprung barrel contacts are beneficial as they may easily be combined with different glazing cavity widths, allow for fast manufacture of the assembly and associated glazings, and provide long lasting flexible electrical connections.

The sprung barrel contact may be provided as a single contact, or may be associated with other contacts by using barrels with multiple pins, or providing receivers for multiple contacts as discussed below. The sprung barrel contact may have a linear barrel, wherein the first contact point is in line with the second contact point, or the barrel may include an angle, such that the first contact point is at an angle to the second contact point.

The pin of the sprung barrel contact may comprise brass, beryllium copper, phosphor-bronze or SK4 steel. The pin of the sprung barrel contact is preferably plated with gold, gold provides an excellent electrical conductivity and provides high protection against corrosion and oxidation. Preferably, the pin of the sprung barrel contact is plated with nickel 1-2 μm in thickness, and then gold 0.1-1 μm in thickness to improve the gold plating durability. Alternatively, the pin may be plated with nickel, palladium nickel, red brass, palladium cobalt, or other metal and metal alloys, depending on the particular requirements of the application. The pin comprises a contact point, and preferably, the contact point is a point-type contact point, preferably a spherical or hemispherical contact point. A point-type contact point, especially a spherical or hemispherical contact point, allows for greatly reduced risk of scratching. A captured spherical contact point is particularly preferred, as this may roll and therefore the risk of scratching is greatly reduced.

The barrel may comprise brass, preferably the brass is coated with beryllium copper or phosphor-bronze.

The barrel of the sprung barrel contact may be formed as a blind hole, with a single pin which may move independently of the barrel. Alternatively, the sprung barrel contact may comprise a pin at each end of the barrel which may move independently of the barrel and each other, known as a “double ended sprung barrel contact”. A double ended sprung barrel contact may be provided, for example, through the use of a barrel with a through hole and a single spring or resilient member that allows the two pins to act upon one another. A double ended sprung barrel contact is advantageous, because a flexible yet secure electrical connection may be made between an electrical component on the first glazing pane and the contact, and also between the contact and the terminal and/or the electrical transmission arrangement, where present. As such, preferably the assembly comprises the contact comprising a first contact point and a second contact point, wherein the contact is at least partially within the aperture, and wherein the contact comprises a double ended sprung barrel contact.

A double ended sprung barrel contact allows a durable, high transmission yet mechanically flexible electrical connection to be made between two different conductive bodies while also providing a streamlined manufacturing process for insulated glazing manufacture, as the assembly may be preassembled and then added to the glazing during manufacture, without costly soldering operations. Such a contact can “float” within the aperture, and thereby easily take up any flex or movement in the glazing panes.

Preferably, the sprung barrel contact, or double ended sprung barrel contact, applies a spring force from 25 g to 500 g. More preferably, the sprung barrel contact, or double ended sprung barrel contact, applies a spring force from 50 g to 250 g. Even more preferably, the sprung barrel contact, or double ended sprung barrel contact, applies a spring force from 80 g to 150 g. Yet more preferably, the sprung barrel contact, or double ended sprung barrel contact, applies a spring force from 90 g to 120 g.

The inventors have discovered that such spring forces allow a secure yet mechanically flexible electrical connection to be made. Spring forces above this range may result in a pin that is not sufficiently compressible, and therefore causes damage to a busbar or a corner key body, or even to the glass panes. Spring forces below this range may result in a pin that has insufficient rebound, and therefore a secure electrical connection is not established.

For some implementations, especially where the electrical component is a busbar for a heating coating or printed heating line, it is preferred that the sprung barrel contact, or double ended sprung barrel contact, is suitable for transmission of 5 amps or more, preferably 10 amps or more.

It is beneficial that a terminal is provided to provide a secure electrical connection with the second contact point. As such, preferably the assembly further comprises a terminal associated with the aperture such that the terminal is in electrical communication with the second contact point when the assembly comprises the contact.

Preferably, the assembly comprises a terminal associated with the aperture, in that when a contact is inserted in the aperture a second contact point of the contact may be in electrical communication with the terminal. The terminal comprises electrically conductive material, such that electrical communication between the contact and the electrical transmission arrangement, where present, may be achieved. Preferably, the terminal comprises copper and/or brass. In some embodiments the terminal may be plated, for example with gold or other conductive material, to improve electrical transmission.

Preferably, the terminal comprises a first portion for contacting the contact, and a second portion for contacting an electrical transmission arrangement. The first portion preferably comprises a plate. In some embodiments the first portion and the second portion are at an angle to one another, in a particularly preferred embodiment the terminal is formed as an “L” with the first and second portions at substantially right angles to one another. This provides a first portion orientated for contacting the contact orientated towards the first glazing pane, and a second portion orientated for contacting an electrical transmission arrangement which passes out of the insulated glazing unit between the glazing panes. The terminal may be inserted into the body during preparation of the insulated glazing. Alternatively, the terminal may be formed within the body during production of the body, for example by injection moulding of the body around the terminal or 3D printing of the body around the terminal.

As discussed above, the terminal may comprise the resilient structure. As such, in some embodiments the terminal comprises at least one spring or resilient material.

In some embodiments, the terminal comprises a spring or resilient material, and is orientated such that it may act upon the contact. Springs and resilient materials as described herein in relation to the contact may be employed.

### Contact Receiving Part

The assembly comprises a contact receiving part. Preferably the contact receiving part is formed as a part of the body, for example as an integral section of the body or as a section adhered to the body. Preferably, the contact receiving part is formed of the same material as the body. In any case, the assembly comprises a body and a contact receiving part which are joined such that the contact receiving part cannot be detached from the body following manufacture of the insulated glazing unit without damage to the assembly. While contact receiving parts within spacer frame components are contemplated, it is beneficial that the contact receiving part makes contact with the electrical component inboard of the spacer frame, such that the electrical component need not make contact with the spacer frame and risk electrification of external surfaces. For example it is beneficial that, where the electrical component comprises a heating coating, the heating coating is edge deleted and the contact receiving part is located sufficiently inboard from the glazing edge that the first contact point may make contact with the heating coating, or a busbar associated with the heating coating.

The contact receiving part comprises an aperture. The aperture may be formed as a blind hole in the contact receiving part, such that a first aperture end is open to form the aperture exit and a second aperture end is closed. In this case, it is advantageous that the terminal is associated with the closed second aperture end, within the aperture.

Alternatively, the aperture may be formed as a through hole in the contact receiving part, such that a first aperture end is open to form the first aperture exit and a second aperture end is open. In this case, it is advantageous that the terminal is associated with the open second aperture end, and forms an end wall of the aperture. In this embodiment, it is preferred that a non-conductive member is between the terminal and the second glazing pane, to prevent electrification of the second glazing pane. In either case it is preferred that the contact receiving part prevents the contact and/or the terminal from directly contacting or electrifying the second glazing pane or an electrical component upon the second glazing pane.

Whatever the shape of the contact, it is preferred that the aperture of the contact receiving part is shaped to allow insertion of the contact without excessive push in force, which may lead to damage, and without excessive gaps, which may cause the contact to deviate from the desired path or may even allow the contact to be released from the aperture during use, leading to a non-functioning apparatus. Where the contact comprises flanges or locating features, the aperture may be formed such that the contact receiving part cooperates with such flanges or locating features, to further improve retention and alignment of the contact.

In some embodiments the assembly may comprise further apertures suitable for further contacts comprising further first contact points, wherein the further apertures are orientated such that the further first contact points directly or indirectly contact one or more electrical components when the body is arranged between the first glazing pane and the second glazing pane. For example, the assembly may comprise multiple contact receiving parts, or multiple apertures within a contact receiving part. An assembly with further apertures may allow for increased power transmission, redundancy, positive and negative polarity of power supply, data and power communication, and/or data and power communication to more than one electrical component.

As such, the contact receiving part may comprise multiple apertures suitable for insertion of contacts, for example the contact receiving part may comprise two, three, four, or more apertures for two, three, four, or more contacts respectively. Such additional apertures may be formed in the same way, or differently from the said aperture.

The contact receiving part may be formed as a single portion. Alternatively, the contact receiving part may be formed as multiple portions. In some embodiments a first contact receiving part portion is inserted into, or formed within, the body, and the contact is adhered within, friction fit with, formed within, or associated with a second contact receiving part portion. During production of the insulated glazing unit the second contact receiving part portion, with the contact, is inserted into the body in alignment with the first contact receiving part portion. This improves the efficiency of production, especially in the case of multiple contacts, because the contacts may be retained in the second contact receiving part portion and inserted as a single unit, preventing manual handling errors.

### Electrical Transmission Arrangement

In some embodiments the assembly further comprises an electrical transmission arrangement suitable for electrical communication with an external power and/or data source outside the insulated glazing.

The electrical transmission arrangement, in use, provides an electrical connection between an external power and/or data source and the electrical component within the insulated glazing unit via the terminal, where present, and the contact.

The electrical transmission arrangement may for example comprise a wire soldered to the terminal and passing out from between the first glazing pane and the second glazing pane to provide an electrical connection. However, such wires have drawbacks, such as increased damage from snagging.

Preferably, the electrical transmission arrangement extends externally from the body less than 1 cm. More preferably, the electrical transmission arrangement extends externally from the body less than 0.5 cm. Even more preferably, the electrical transmission arrangement does not extend externally from the body. As used herein, the phrase “extends externally from” is taken to mean “extending away from a surface orientated towards the exterior of the insulated glazing unit”, and any measurement is carried out with the electrical transmission arrangement extended to its full extent perpendicular to said surface, the measurement being from the end of the electrical transmission arrangement to the surface, or where the electrical transmission arrangement is not in contact with the surface itself, from a plane aligned with the surface.

The electrical transmission arrangement may comprise a connecting element, which may be connected to an external connector for supplying external power and/or data. The use of a connecting element may allow for electrical connection to be carried out at the point of installation of the insulated glazing unit into the glazing aperture in an efficient manner, and may eliminate the use of wires passing out of the glazing. The use of an electrical transmission arrangement comprising a connecting element allows reversible joining of an external electrical connector without disturbing the hermetic seal. As such, an insulated glazing may be produced of high quality, without a need to re-gas the insulated glazing following electrical connection on-site.

The connecting element may for example be a pin, male plug, female plug, screw, or flat plate. Preferably the connecting element comprises a blind hole, preferably the blind hole is suitable for a pin, male plug, or screw. Such a connection means provides a gas tight electrical transmission arrangement between the terminal and a power and/or data source outside the glazing. The gas tightness of the electrical transmission arrangement may be enhanced by the use of a sealant, preferably a butyl sealant, provided the sealant is not applied such that it prevents electrical connection.

The electrical transmission arrangement preferably comprises a means to aid location of the external electrical connector by cooperation with associated means comprised within or upon the electrical connector. Such location means may preferably comprise magnets which are adapted to coordinate with magnets in or on the electrical connector.

The electrical transmission arrangement preferably comprises a locking means to prevent unintended disconnection of the electrical connector. Such locking means may preferably comprise biased hooks, screw fasteners, and/or magnets which are associated to cooperate with associated means comprised within or upon the electrical connector.

In some embodiments, the connecting element comprises a conductive insert, wherein the conductive insert is in electrical communication with the terminal in a secure and solder-free manner. Preferably, the conductive insert is in direct electrical communication with the terminal, and preferably, the conductive insert also holds the terminal in place within the body. However, wires or other conductors may be employed within the assembly to provide electrical connection between the terminal and the conductive insert where desired. Preferably, the conductive insert comprises a blind hole as disclosed above in relation to the connecting element.

In some embodiments the conductive insert may be captured in the body during the forming process of the body, for example during injection moulding or 3D printing.

Alternatively, the conductive insert may be inserted into the body after the body has formed. In such embodiments, the body may comprise a through hole for insertion of the conductive insert. In alternative embodiments the body may comprise a blind hole for guiding insertion of the conductive insert, wherein a portion of the body is pierced during insertion of the conductive insert. This may provide a more gas tight electrical connection.

Where the conductive insert is to be inserted into the body after the body has been formed, preferably some retaining means is provided. In some embodiments the conductive insert may be retained by friction and/or glue and or external screw threads. A conductive insert that is retained in the body by external screw threads may be termed a conductive threaded insert. Preferably, the electrical transmission arrangement comprises a conductive threaded insert. Such threaded conductive inserts may include knurled sections, or screwdriver head apertures, to aid insertion. Where the body is formed with a hole to cooperate with a threaded conductive insert, such a hole may be provided with threads. Alternatively, the threaded conductive insert may cut threads into the body during insertion.

A threaded conductive insert comprising a blind hole is particularly beneficial, as this provides a secure and durable electrical connection, while also preserving the atmosphere of the insulated glazing cavity.

The electrical transmission arrangement is preferably a threaded conductive insert in direct electrical connection with the terminal and comprising a blind hole suitable for an external connector, preferably wherein the external connector is a screw type connector.

The skilled person should note that such conductive inserts, and particularly threaded inserts, may be applied more broadly than solely in the presently disclosed invention, but may instead be applied to conventional spacer frame members with alternative electrical connection means. As such, there is provided: a threaded conductive insert suitable for a spacer frame member comprising a blind hole suitable for a connector, preferably wherein the connector is a screw type connector; a spacer frame member comprising such a threaded conductive insert; and an insulated glazing unit comprising a spacer frame member comprising such a conductive insert.

### Body

The assembly comprises a body, the body comprising a first wall and a second wall. The first wall is arranged such that it will be orientated toward the first glazing pane and the second wall is arranged such that it will be orientated toward the second glazing pane, during use. The first and/or second wall of the body may be provided with a metal foil to improve gas tightness of the insulated glazing unit.

It is generally desirable that assemblies for insulated glazing units do not overly interrupt the passage of light and vision of the consumer through the insulated glazing unit. As such, in some embodiments the assembly is suitable for cooperating with spacer frame components, such that it is held in a perimeter region of the insulated glazing unit and may not migrate into a central region and overly interrupt the passage of light through the insulated glazing unit.

Preferably, the body is an insulated glazing unit spacer frame component, such as a spacer frame profile or connector. Spacer frame profiles are typically straight hollow pieces, often containing desiccant. Spacer frame connectors typically comprise a pair of arms which cooperate with spacer frame profiles to join them together. A spacer frame connector comprising two aligned arms is termed a linear connector, while a spacer frame connector comprising two arms at an angle is termed a corner connector, also known as a corner key. Typical insulated glazing units comprise four spacer frame corner connectors, one at each corner of a rectangular insulated glazing unit.

The body may be a spacer frame profile or a linear connector. However, preferably the body is a spacer frame corner connector, as this allows electrical connection to be made in a corner of the insulated glazing unit and thereby reduces the visibility of the assembly to the end user of the insulated glazing unit.

The design of the connecting arms should be such that a secure connection can be provided between the spacer frame connector and cooperating spacer frames, while allowing a reasonable push in force and a high pull out force. If the push in force is too high the connection may not be complete, leading to an insecure connection. In addition, if the push in force is too high off angle force may be applied during manufacture, leading to damage of the connector and/or the profile. If the pull out force is too low an insecure connection may result. In addition, it is preferred that a gas tight connection is made between the connector and the profile to prevent any gas leakage from the insulated glazing unit and/or escape of desiccant from the spacer frame profile.

When combined with spacer frame members, the body may form a part of the periphery of the spacer frame and therefore interrupt other spacer frame members. However, in some embodiments the body may be more permeable to gas than alternative spacer frame members, potentially allowing air from the atmosphere to enter the cavity, leading to condensation and reduced insulating properties. Therefore, it is desirable to minimise the interruption of the spacer frame by the body. As such, preferably the body has an interruption length, defined as the length of the body that runs between the two spacer frame members adjacent to the body while in use, of less than 10 cm, preferably less than 5 cm, more preferably less than 2 cm. Where the assembly has a body that is linear the interruption length is the linear interruption length and is measured on a line through the centre of the adjacent spacer frame members. Where the assembly has a body that is not linear, such as when the assembly comprises a corner key, the interruption length is measured through an inflection point in line with the centre of both adjacent space frame members.

Preferably, the body comprises one or more of polyethylene (PE), polycarbonates (PC), polystyrene, polybutadiene, polynitrils, polyesters, polyurethanes, polymethylmetacrylates, polyacrylates, polyamides, polyethylene terephthalate (PET), polybutylene terephthalate (PBT), polypropylene (PP), acrylonitrile butadiene styrene (ABS), acrylic ester-styrene-acrylonitrile (ASA), acrylonitrile butadiene styrene polycarbonate (ABS/PC), Contains styrene-acrylonitrile (SAN), polyethylene terephthalate polycarbonate (PET/PC), polybutylene terephthalate polycarbonate (PBT/PC), or copolymers or derivatives or mixtures thereof.

Where the body is a printed body, preferably the printed body comprises polyamide 12 (PA12), polyamide 11 (PA11), polyamide 2200 (PA2200), polypropylene, acrylonitrile butadiene styrene (ABS), acrylic ester-styrene-acrylonitrile (ASA), polycarbonate, or copolymers or derivatives or mixtures thereof.

Preferably, the body comprises a lacquer or coating. Lacquers and coatings may be provided to alter the colour, texture, UV resistance, and sealant compatibility of the body.

A lacquer or coating may be applied to the body, for example to improve the UV resistance of the body. In embodiments the entire body is provided with a lacquer or coating. Alternatively, only surfaces that will be exposed to UV light following insulated glazing unit assembly may be provided with a lacquer or coating.

In a preferred embodiment of the first aspect of the present invention, there is provided an assembly suitable for arrangement between a first glazing pane and a second glazing pane of an insulated glazing, wherein the first glazing pane comprises an electrical component on a first major surface orientated towards the second glazing pane, the assembly comprising:
a spacer frame corner connector comprising a first wall to be orientated towards the first glazing pane and a second wall to be orientated towards the second glazing pane;
a contact receiving part comprising an aperture;
a sprung barrel contact, preferably a double ended sprung barrel contact, comprising a first contact point and a second contact point, wherein the sprung barrel contact is at least partially within the aperture;
a terminal associated with the aperture such that the terminal is electrical communication with the second contact point; and
an electrical transmission arrangement suitable for electrical communication between the terminal and an external power and/or data source outside the insulated glazing, wherein: the aperture is orientated such that the first contact point directly or indirectly contacts the electrical component when the body is arranged between the first glazing pane and the second glazing pane; and
the sprung barrel contact is tensioned during manufacture of the insulated glazing, such that following manufacture of the insulated glazing the first contact point is held securely against the electrical component.

Such a preferred embodiment provides a long lasting, durable and secure connection to the electrical component.

According to a second embodiment of the present invention, there is provided a method of manufacturing an assembly according to any preceding claim, wherein the body and/or contact receiving part is injection moulded, extruded or 3D printed, preferably the contact receiving part is an integral part of the body and the body and the contact receiving part are injection moulded or 3D printed, most preferably the contact receiving part is an integral part of the body and the body and the contact receiving part is 3D printed.

In some embodiments, the body is injection moulded, especially when the body is a spacer frame connector. An injection moulded body may be manufactured in a cost effective manner. Alternatively, the body may be 3D printed. A 3D printed body may offer an increased range of surface textures and materials. A 3D printed body may be provided by, among other methods, multijet fusion (MJF) selective laser sintering (SLS), stereolithography (SLA), polyjet, fused deposition modelling (FDM), and selective laser melting (SLM).

Where the body is 3D printed, mechanical and thermal post processing operations may be applied to the body. Such processes may include, among others, vibratory grinding, blasting, milling, lathing, light treatment, thermal treatment, chemical smoothing.

The contact receiving part may be produced separately from the body, and then joined with the body to provide the assembly. In such cases the contact receiving part may be produced, for example, by 3d printing, extruding, moulding, additive manufacturing, subtractive manufacturing such as computer numerical control (CNC), lathing or other suitable methods.

Optional features herein disclosed in relation to the first aspect of the present invention may be applied to the second aspect of the present invention in any combination.

As referred to in the first aspect of the present invention, the inventors have provided assemblies suitable for use in insulated glazing units. As such, according to a third aspect of the present invention there is provided an insulated glazing comprising a first glazing pane, a second glazing pane, and an assembly between the first glazing pane and the second glazing pane, wherein the first glazing pane comprises an electrical component on a first major surface orientated towards the second glazing pane, wherein the assembly comprises:
a body comprising a first wall orientated towards the first glazing pane and a second wall orientated towards the second glazing pane;
a contact receiving part comprising an aperture;
a contact comprising a first contact point and a second contact point, wherein the contact is at least partially within the aperture;
a terminal associated with the aperture such that the terminal is in electrical communication with the second contact point; and
an electrical transmission arrangement suitable for electrical communication between the terminal and an external connector for supplying power and/or data from a source outside the insulated glazing, wherein:
the aperture is orientated such that the first contact point directly or indirectly contacts the electrical component; and
the assembly comprises a resilient structure that is tensioned during manufacture of the insulated glazing, such that the first contact point is held securely against the electrical component, and wherein the first contact point has a contact area of less than 1 cm².

The insulated glazing unit provided with such an assembly is therefore provided with a secure solder free electrical connection to the electrical element.

Preferably, the insulated glazing unit is gas tight to EN 1279-3.

As is known by the skilled person, the insulated glazing comprises a cavity between the first glazing pane and the second glazing pane. Preferably, the cavity comprises insulating gas. Preferably, the cavity comprises nitrogen or argon as insulating gas.

The insulated glazing unit may comprise additional glazing panes. For example, an insulated glazing unit comprising a single additional glazing pane, such that there are three glazing panes in total, may be termed a “triple” insulated glazing unit or “triple IGU”. The additional glazing pane may be provided between the first and second glazing panes, or on either side.

The first, second, and any additional glazing panes may independently comprise a single glazing sheet or a laminated glazing sheet. Preferred glazing panes include a single sheet of soda-lime silica glass, a single sheet of polycarbonate, and a laminated glass comprising two or more sheets of glass with adhesive interlayers, preferably polyvinyl butyral adhesive interlayers, between.

The first, second and any additional glazing panes may independently comprise functional coatings. Preferred functional coatings include, for example, low-emissivity, self-cleaning, infra-red reflecting and solar control coatings.

Optional features of the first aspect of the present invention may be applied in any combination to the third aspect of the present invention. In particular:
in some embodiments the contact comprises a sprung barrel connector, more preferably the contact comprises a double ended sprung barrel connector; and/or
in some embodiments, the terminal comprises at least one spring or resilient material; and/or in some embodiments the electrical transmission arrangement comprises a threaded insert, preferably a threaded insert with a blind hole.

While insulated glazing units as disclosed herein may incorporate a range of electrical components, preferably the electrical component comprises a busbar, more preferably a busbar for a heating coating or printed heating line. Where the electrical component comprises a busbar for a heating coating or a printed heating line, preferably the assembly is suitable for the transmission of 230 volt alternating current of at least 2.5 amps, more preferably the assembly is suitable for the transmission of 230 volt alternating current of at least 5 amps, yet more preferably the assembly is suitable for the transmission of 230 volt alternating current of at least 10 amps. The assembly may be adapted to provide such transmission, for example, by the use of multiple contacts, for example 4 contacts may be used.

According to a fourth aspect of the present invention, there is provided a method of manufacturing an insulated glazing unit according to the third aspect, comprising the steps of:
i) providing an assembly according to the first aspect of the present invention and one or more spacer frame members;
ii) joining the assembly and the one or more spacer frame members together to provide a spacer frame;
iii) providing a first sheet of glazing material comprising an electrical component on a first major face and a second sheet of glazing material;
iv) arranging the second sheet of glazing material in a face-to-face arrangement with the first sheet of glazing material with the spacer frame therebetween to provide a cavity; and
v) applying a sealant between the first glazing pane and the second glazing pane around the periphery of the spacer frame.

Preferably, prior to the step of applying the sealant, the electrical transmission arrangement is reversibly blinded, masked or covered such that it may be revealed following the step of sealing the cavity with a seal.

As disclosed herein, where a parameter is expressed as being from a first value to a second value, the range is inclusive of the first and second values. Similarly, where a parameter is expressed as between a first value and a second value, the range is inclusive of the first and second values.

The invention is now described with reference to the figures, in which:

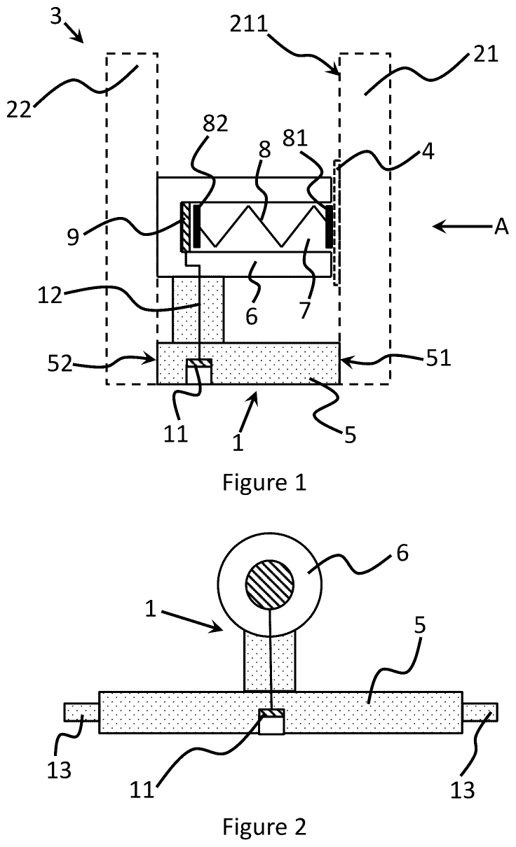

FIG. 1 depicts a first assembly suitable for arrangement between a first glazing pane and a second glazing pane.

FIG. 2 depicts the first assembly as viewed along arrow A.

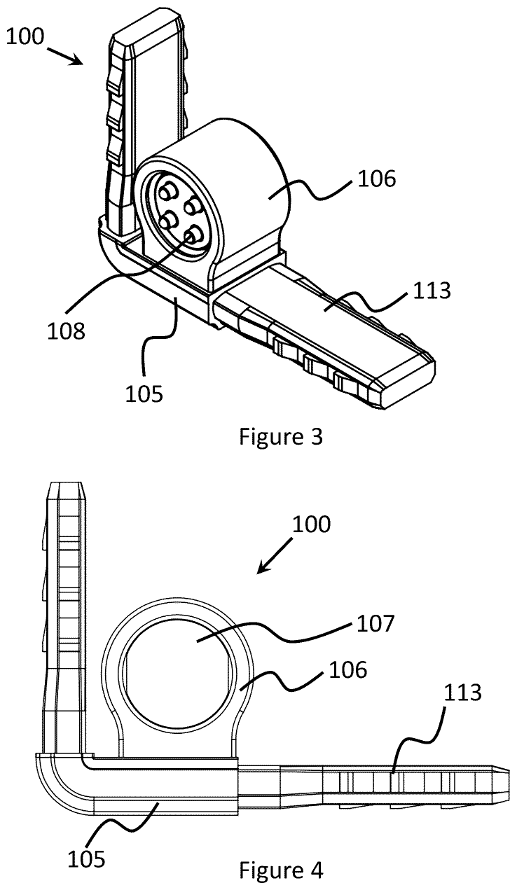

FIG. 3 depicts a perspective view of a second assembly suitable for arrangement between a first glazing pane and a second glazing pane.

FIG. 4 depicts a side view of the second assembly of FIG. 3.

FIG. 1 depicts a first assembly 1 suitable for arrangement between a first glazing pane 21 and a second glazing pane 22 of an insulated glazing 3. In this figure the glazing sheets are shown with dashed lines. The first glazing pane 21 comprises an electrical component 4 on a first major surface 211 orientated towards the second glazing pane 22. In this figure the electrical component 4 is shown with dashed lines.

The assembly 1 comprises a body 5 comprising a first wall 51 to be orientated towards the first glazing pane 21 and a second wall 52 to be orientated towards the second glazing pane 22. In this embodiment the assembly 1 further comprises a contact receiving part 6 comprising an aperture 7, wherein the aperture is suitable for a contact 8 comprising a first contact point 81 and a second contact point 82.

The aperture 7 is orientated such that the first contact point 81 directly or indirectly contacts the electrical component 4 when the assembly 1 is arranged between the first glazing pane 21 and the second glazing pane 22.

The assembly comprises a resilient structure that is tensioned during manufacture of the insulated glazing 3, such that following manufacture of the insulated glazing 3 the first contact point 81 is held securely against the electrical component 4. In the embodiment depicted in FIG. 1, the contact 8 comprises a resilient structure, in this case a spring is depicted.

In the embodiment depicted in FIG. 1, the assembly further comprises a terminal 9, wherein the terminal 9 is associated with the aperture 7 such that the terminal is in electrical communication with the second contact point 82.

In the embodiment depicted in FIG. 1, the assembly further comprises an electrical transmission arrangement suitable for electrical communication with an external power and/or data source outside the insulated glazing. In the embodiment of FIG. 1, the electrical transmission arrangement comprises a connecting element 11 and a wire 12.

Also in FIG. 1, it is shown that the body 5 of this embodiment is suitable for forming a section of the insulated glazing peripheral spacer frame.

The contact 8 is shown in FIG. 1 floating contact comprising bent wire or spring with contact portions at each end. Such a contact may be provided using a double ended sprung barrel contact.

In FIG. 1 arrow A indicates the orientation of the embodiment in FIG. 2.

FIG. 2 depicts the first embodiment of the invention shown in FIG. 1 orientated according to arrow A of FIG. 1. Like numbering is used in FIG. 2 as with FIG. 1, and the contact and glazing sheets are omitted for clarity. From FIG. 2 it can be seen that in this embodiment the contact receiving part 6 takes the form of a cylinder with cylindrical aperture 7, however the shape of the contact receiving part 6 is not particularly limited, other than it should comprise an aperture 7 suitable for insertion of the contact. It is preferable that the aperture 7 is shaped to match the shape of the contact, such that the contact cannot significantly deviate from the central axis of the aperture 7. Such a deviation may significantly reduce the connection quality. As such, when the contact comprises a circular cross section it is preferable that the aperture 7 is of circular cross section. In this embodiment, the body 5 is formed as a spacer frame linear connector, with connecting arms 13 suitable for cooperation with spacer frame profiles. The skilled person will appreciate that the body may be formed with angled sections and arms, to provide a similar spacer frame corner connector.

FIGS. 3 and 4 depict a second assembly 100 suitable for arrangement between a first glazing pane and a second glazing pane of an insulated glazing. The assembly 100 comprises a body 105 and a contact receiving part 106 comprising an aperture 107, wherein the aperture is suitable for receiving a contact. As in FIG. 2, the shape of the contact receiving part 106 is not particularly limited, other than it should comprise an aperture 107 suitable for insertion of the contact 108. The aperture 107 is orientated such that the first contact point of the contact directly or indirectly contacts an electrical component when the assembly 100 is arranged between a first glazing pane and a second glazing pane.

The assembly of FIG. 3 comprises a resilient structure that is tensioned during manufacture of the insulated glazing, such that following manufacture of the insulated glazing the first contact point is held securely against the electrical component, accomplished by the contact 108 which comprises a double ended sprung barrel contact (pogo pin).

In the embodiment illustrated in FIGS. 3 and 4, the body 105 is formed as a spacer frame corner connector, with connecting arms 113 suitable for cooperation with spacer frame profiles and for forming a section of the insulated glazing peripheral spacer frame, in this case a corner key. The connecting arms 113 have serrations on the edges thereof to improve fitting and cooperation (especially retention) in the spacer frame.

The invention will now be described with reference to an example assembly and an example insulated glazing comprising said example assembly.

A corner key body was produced by 3D printing and a terminal and contact inserted to provide an assembly. In this case the terminal was an L shaped terminal comprising a bent brass plate, the contact was a double ended sprung barrel contact—“Pogo Pin” available from N&H Technology GmbH—and the electrical transmission arrangement comprised a threaded insert with a blind screw hole. The assembly was joined together with spacer bars, two conventional corner keys, and a further corner key assembly according to the invention, to provide a spacer frame. The spacer frame was then arranged between two glazing panes. The glazing panes comprised glass, and one glazing pane was provided with a conductive coating (fluorine doped tin oxide) and a pair of busbars. The corner key assemblies were designed such that when the spacer frame is between the glass panes the contacts are aligned with the busbars. The double ended sprung barrel contact was tensioned by the weight of the glass panes, such that the contact is pressed securely against both the terminal and the busbar. The threaded insert was blanked with a removable blanking screw, and the insulated glazing was then sealed and the cavity charged with argon. The removable blanking screw was then removed to provide an insulated glazing unit with a connection that may be easily accessed. The thus provided insulated glazing was tested and shown to conform EN 1279-3. The security of the contact was tested by applying forces against the glass panes.

Reference Signs

| | |
|---|---|
| 1 | Assembly |
| 3 | Insulated glazing |
| 4 | Electrical component |
| 5 | Body |
| 6 | Contact receiving part |
| 7 | Aperture |
| 8 | Contact |
| 9 | Terminal |
| 11 | Connecting element |
| 12 | Wire |
| 13 | Connecting arms |
| 21 | Glazing pane |
| 22 | Glazing pane |
| 51 | Wall |
| 52 | Wall |
| 81 | Contact point |
| 82 | Contact point |
| 100 | Assembly |
| 105 | Body |
| 106 | Contact receiving part |
| 107 | Aperture |
| 108 | Contact |
| 113 | Connecting arms |
| 211 | Major surface |

1. An assembly suitable for arrangement between a first glazing pane and a second glazing pane of an insulated glazing, wherein the first glazing pane comprises an electrical component on a first major surface orientated towards the second glazing pane, the assembly comprising:
a body comprising a first wall to be orientated towards the first glazing pane and a second wall to be orientated towards the second glazing pane; and
a contact receiving part comprising an aperture, wherein:
the aperture is suitable for a contact comprising a first contact point and a second contact point;
the aperture is orientated such that the first contact point is positioned to be suitable for direct or indirect contact with the electrical component when the assembly is arranged between the first glazing pane and the second glazing pane; and
the assembly comprises a resilient structure that is tensioned during manufacture of the insulated glazing, such that following manufacture of the insulated glazing the first contact point is held securely directly or indirectly against the electrical component; and wherein the first contact point has a contact area of less than 1 cm².

2. An assembly according to claim 1, further comprising the contact comprising a first contact point and a second contact point, wherein the contact is at least partially within the aperture, preferably the contact comprises a sprung barrel contact, more preferably the contact comprises a double ended sprung barrel contact.

3. An assembly according to claim 2, wherein the sprung barrel contact applies a spring force from 25 g to 500 g, more preferably the sprung barrel contact applies a spring force from 50 g to 250 g, even more preferably the sprung barrel contact applies a spring force from 80 g to 150 g.

4. An assembly according to any preceding claim, further comprising a terminal associated with the aperture such that the terminal is in electrical communication with the second contact point when the assembly comprises the contact, preferably the terminal comprises at least one spring or resilient material.

5. An assembly according to any preceding claim, further comprising an electrical transmission arrangement suitable for electrical communication with an external power and/or data source outside the insulated glazing, preferably the electrical transmission arrangement does not extend externally from the body.

6. An assembly according to claim 5, wherein the electrical transmission arrangement comprises a conductive insert, preferably the conductive insert comprises a threaded conductive insert and/or a conductive insert with a blind hole, more preferably the conductive insert comprises a threaded conductive insert with a blind hole.

7. An assembly according to any preceding claim, wherein the body is a spacer frame component, preferably the body is a spacer frame connector, more preferably the body is a spacer frame corner connector.

8. An assembly according to claim 7 wherein the body has an interruption length of less than 10 cm, preferably less than 5 cm, more preferably less than 2 cm.

9. An assembly according to any preceding claim, wherein the body comprises polyethylene (PE), polycarbonates (PC), polystyrene, polybutadiene, polynitrils, polyesters, polyurethanes, polymethylmetacrylates, polyacrylates, polyamides, polyethylene terephthalate (PET), polybutylene terephthalate (PBT), polypropylene (PP), acrylonitrile butadiene styrene (ABS), acrylic ester-styrene-acrylonitrile (ASA), acrylonitrile butadiene styrene polycarbonate (ABS/PC), Contains styrene-acrylonitrile (SAN), polyethylene terephthalate polycarbonate (PET/PC), polybutylene terephthalate polycarbonate (PBT/PC), or copolymers or derivatives or mixtures thereof.

10. A method of manufacturing an assembly according to any preceding claim, wherein the body and/or the contact receiving part is injection moulded, extruded or 3D printed, preferably the contact receiving part is an integral part of the body and the body and the contact receiving part are injection moulded or 3D printed, most preferably the contact receiving part is an integral part of the body and the body and the contact receiving part is 3D printed.

11. An insulated glazing comprising a first glazing pane, a second glazing pane, and an assembly between the first glazing pane and the second glazing pane, wherein the first glazing pane comprises an electrical component on a first major surface orientated towards the second glazing pane, wherein the assembly comprises:
a body comprising a first wall orientated towards the first glazing pane and a second wall orientated towards the second glazing pane;
a contact receiving part comprising an aperture;
a contact comprising a first contact point and a second contact point, wherein the contact is at least partially within the aperture;
a terminal associated with the aperture such that the terminal is in electrical communication with the second contact point; and
an electrical transmission arrangement suitable for electrical communication between the terminal and an external power and/or data source outside the insulated glazing, wherein:
the aperture is orientated such that the first contact point directly or indirectly contacts the electrical component; and
the assembly comprises a resilient structure that is tensioned during manufacture of the insulated glazing, such that the first contact point is held securely directly or indirectly against the electrical component, wherein
the first contact point has a contact area of less than 1 cm².

12. An insulated glazing according to claim 11, wherein the contact comprises a sprung barrel connector, more preferably the contact comprises a double ended sprung barrel connector.

13. An insulated glazing according to claim 11 or claim 12, wherein the terminal comprises at least one spring or resilient material and/or wherein the electrical transmission arrangement comprises a threaded conductive insert, preferably a threaded conductive insert with a blind hole.

14. An insulated glazing according to any of claims 11 to 13, wherein the electrical component comprises a busbar, preferably a busbar for a heating coating.

15. A method of manufacturing an insulated glazing according to any of claims 11 to 14, comprising the steps of:
i) providing an assembly according to the first aspect of the present invention and one or more spacer frame members;
ii) joining the assembly and the one or more spacer frame members together to provide a spacer frame;
iii) providing a first sheet of glazing material comprising an electrical component on a first major face and a second sheet of glazing material;
iv) arranging the second sheet of glazing material in a face-to-face arrangement with the first sheet of glazing material with the spacer frame therebetween to provide a cavity; and
v) applying a sealant between the first glazing pane and the second glazing pane around the periphery of the spacer frame.

16. A method according to claim 15, wherein, prior to the step of applying the sealant, the electrical transmission arrangement is reversibly blinded, masked or covered such that it may be revealed following the step of sealing the cavity with a seal.
